(19) United States
(12) Patent Application Publication
(10) Pub. No.: US 2023/0415369 A1
(43) Pub. Date: Dec. 28, 2023

(54) Rotary Tool Assembly

(71) Applicant: EIMA S.R.L., Parma (IT)

(72) Inventor: Alessio FERRAIA, Parma (IT)

(21) Appl. No.: 18/248,822

(22) PCT Filed: Oct. 13, 2021
(86) PCT No.: PCT/IB2021/059406

§ 371 Date: Apr. 12, 2023

(30) Foreign Application Priority Data
Oct. 14, 2020 (IT) 102020000024274

(51) Int. Cl. B27G 13/00

(52) U.S. Cl. CPC B27G 13/007

(57) ABSTRACT

A rotary tool assembly is described including a tool arrangement with two ring-shaped tool holders, two tool bodies each fixed to a respective tool holder, two adjusting screws each coupled to two threaded bushings in opposite directions each fixed to a respective tool holder, two transmission shafts each configured to drive a rotation of a respective adjusting screw, and a crown arrangement configured to transmit motion from a motor arrangement to the transmission shafts, the crown arrangement including a ring and a rotatably ring gear coupled to the ring and arranged to receive motion from the motor arrangement and to transfer motion to both transmission shafts.

### BACKGROUND OF THE INVENTION

The invention concerns a rotary tool assembly, in particular a rotary tool assembly including one or more pairs of rotating took (milling cutters) coaxial and with adjustable mutual distance.

Specifically, but not exclusively, the invention can be applied for the processing of wood and wood derivatives, plastics and composite materials, in mechanical processing, etc.

The prior art includes various examples of assemblies for rotary tools. Patent publication IT 201700050271 A1, in the name of the same applicant, shows an example of a rotary tool assembly.

The adjustable rotary tools (i.e. with the possibility of adjusting the mutual axial distance between the took) of the prior an can be improved, in particular as regards the precision in the adjustment of the tools, the rigidity and/or compactness of the assembly, as well as its versatility of use.

### SUMMARY OF THE INVENTION

An object of the invention is to provide an adjustable assembly capable of in obviating one or more of the aforementioned limitations and drawbacks.

An object of the invention is to realize an assembly of an adjustable type rotary tool that is alternative to those of the prior art.

An advantage is to ensure a constant and uniform production quality over time, in particular by avoiding any possible variation or inhomogeneity caused by personal choices of the individual operators.

An advantage is to increase the production efficiency of the tools.

An advantage is to reduce the unproductive times due to the change of tools and/or to reduce, in general, the manual interventions, with a consequent increase in safety and guarantee of safety for the operators.

An advantage is to significantly reduce the general costs of production and/or to provide a standardized system that can be reused over time.

An advantage is to make available a support system for rotating tools, with adjustable reciprocal distance of the tools, winch allows their control and adjustment by remote programming.

Other advantages are to provide an adjustable rotary tool assembly with high fluidity and regularity of the adjustment movements, with a particularly rigid and compact structure, with high accuracy in adjustment even after a long period of use, with a reduced risk of blockages, seizures, radial and/or axial oscillations between moving pans, misalignments of mechanical parts during the adjustment movement.

An advantage is to give rise to an extremely versatile assembly, provided, in particular, with a portion that controls the adjustment and which in practice is not subject to wear, so that the assembly can receive various types of cutter bodies or combinations of cutter bodies, with the possibility of replacing only the portion subject to wear, while maintaining the portion that controls the adjustment.

These objects and advantages, and others besides, are achieved by an adjustable rotary tool according to one or more of the claims reported below.

### BRIEF DESCRIPTION OF THE DRAWINGS

The invention can be better understood and implemented with reference to the attached drawings which illustrate non-limiting examples of implementation, wherein:

FIG. 1 schematically shows a possible application of a rotary tool assembly made according to the invention;

FIG. 2 shows, exploded and assembled, a first example of a rotary tool assembly made according to the invention;

FIG. 3 shows the hub arrangement of the assembly of FIG. 2;

FIG. 4 shows the guide arrangement of the assembly of FIG. 2;

FIG. 5 shows the lower tools arrangement of the assembly of FIG. 2;

FIG. 6 shows the upper tools arrangement of the assembly of FIG. 2;

FIG. 7 shows the second guide arrangement of the assembly of FIG. 2;

FIG. 8 shows the drive arrangement of the assembly of FIG. 2,

FIG. 9 shows the CPU arrangement of the assembly of FIG. 2;

FIG. 10 shows the battery arrangement of the assembly of FIG. 2;

FIG. 11 shows the crown arrangement of the drive arrangement of FIG. 2;

FIG. 12 shows a motor arrangement of the drive arrangement of FIG. 8;

FIG. 13 shows a transmission shaft of the drive arrangement of FIG. 8;

FIG. 14 shows another transmission shaft of the drive arrangement of FIG. 8;

FIG. 15 shows a micro-limit switch arrangement of the CPU arrangement of FIG. 9;

FIG. 16 shows, exploded and assembled, a second example of a rotary tool assembly made according to the invention;

FIG. 17 shows the second guide arrangement of the assembly of FIG. 16;

FIG. 18 shows the drive arrangement of the assembly of FIG. 16;

FIG. 19 shows the crown arrangement of the drive arrangement of FIG. 13,

FIGS. 20 and 21 are two longitudinal sections, according to two different section in planes, of the assembly of FIG. 2;

FIGS. 22 and 23 are two longitudinal sections, according to two different section planes, of the assembly of FIG. 16.

### DETAILED DESCRIPTION

With reference to the aforementioned figures, similar elements of different embodiment examples have been indicated for sake of conciseness with the same numbering.

The reference numeral 1 generally indicates a rotary tool assembly which may be used, in particular, in the processing of wood and wood derivatives, plastics and composite materials, in mechanical processing, etc.

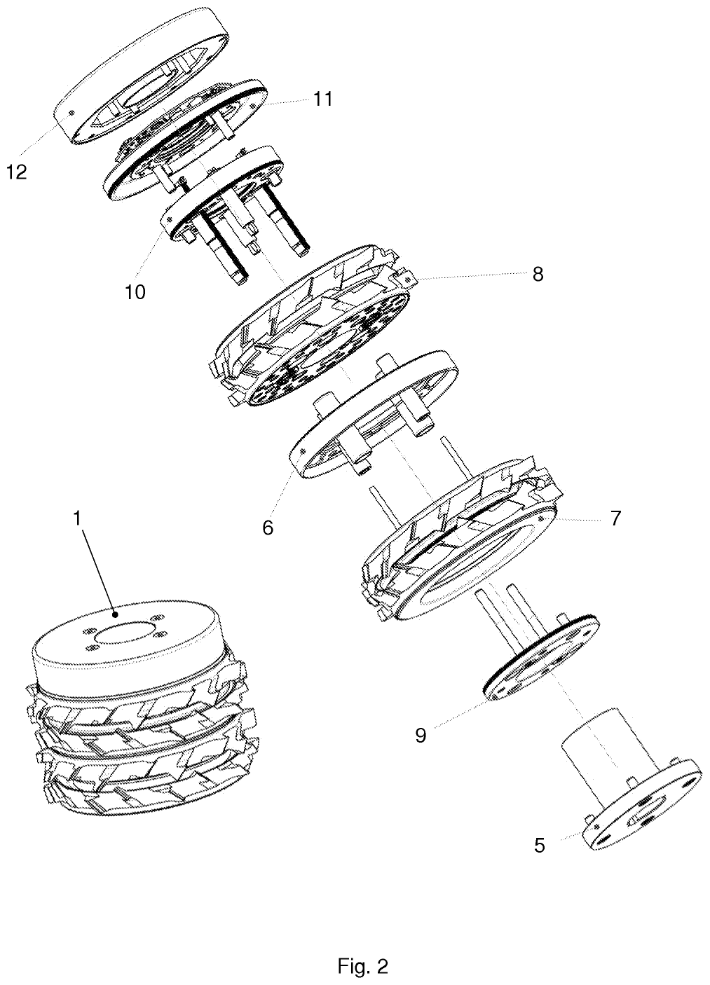

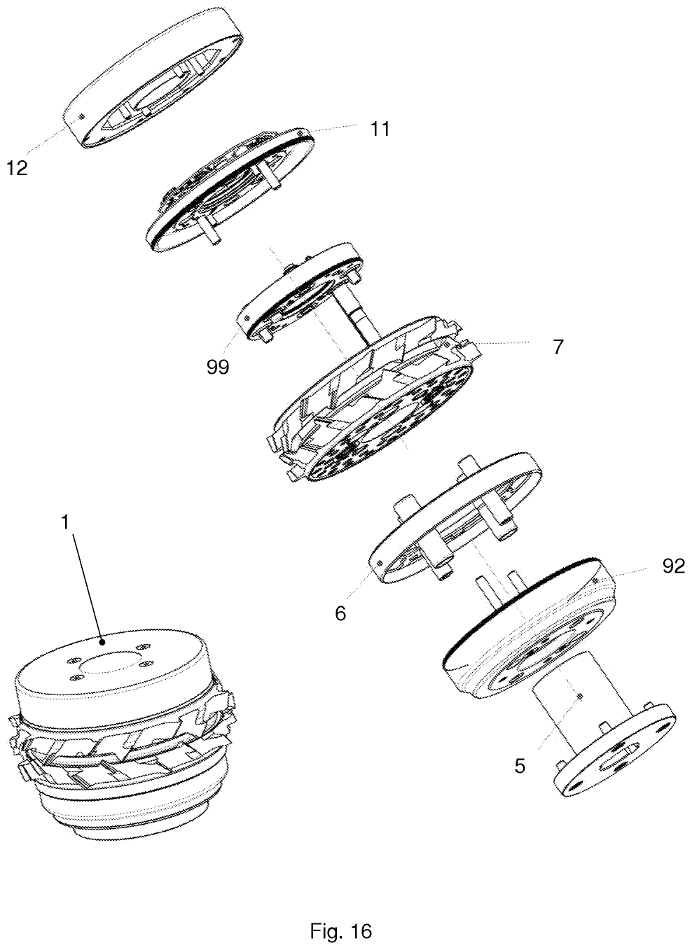

The rotary tool assembly 1 includes a plurality of arrangements. The arrangements may be assembled together in various combinations so as to allow a plurality of different variants to be set up. Two of these possible variants are shown in the attached figures. A first variant, configured for the control of two pairs of tool bodies (milling cutter bodies), is shown as a whole in FIG. 2. A second variant, configured for the control of a pair of tool bodies (milling cutter bodies), is shown in as a whole in FIG. 16.

This system has been adopted in order to better manage the replacement of worn tools, for any replacement of faulty elements and furthermore, to provide a suitable and performing solution with respect to the customer's needs.

A difference between the two variants of FIGS. 2 and 16 is represented by the number of pairs of tool bodies, i.e. two pairs in the version of FIG. 2 and one pair in the version of FIG. 16. Furthermore, since in the version of FIG. 16 there is space not occupied by a second pair of tool bodies, a is possible to mount tool bodies with a greater machining range, with reference to the thickness of the piece to be machined.

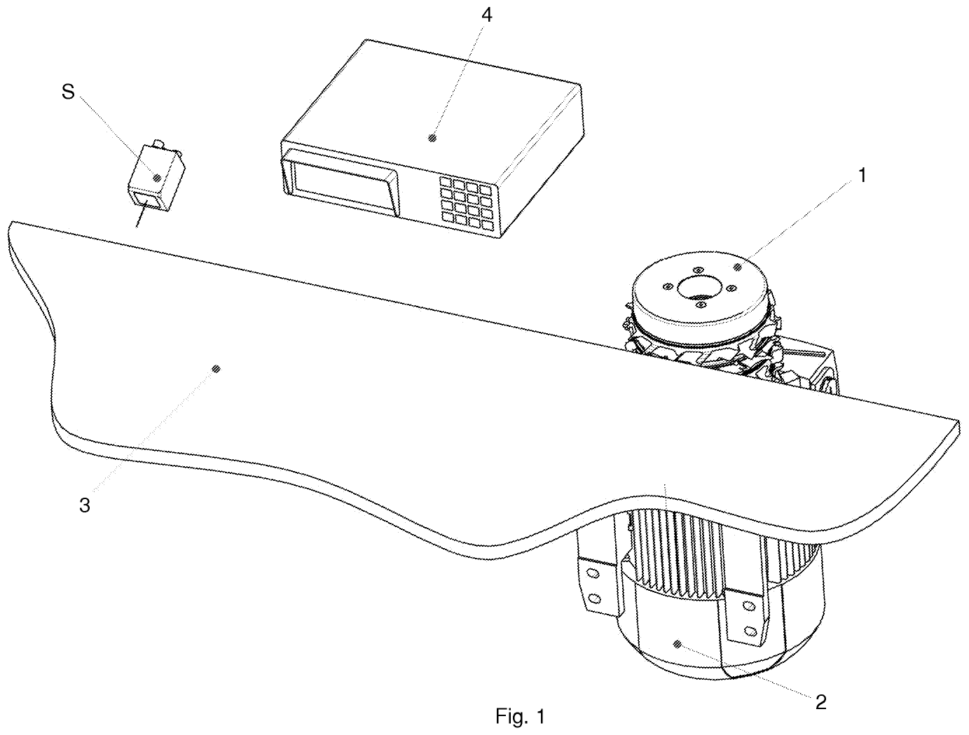

FIG. 1 shows an example of application of a rotary tool assembly, in particular of the assembly of FIG. 2. With reference to FIG. 1, with 1 the rotary tool assembly is indicated, with 2 a motor for driving the assembly (motor 2 may belong, in particular, to a machining machine, for example a CNC machine tool with one, two, three or more machining axes), with 3 a piece (for example a panel) to be machined, with 4 a controller (for example a PLC) for the management of the assembly, with S an optical sensor configured to detect one or more characteristics of the machined piece and usable for the feedback control of the assembly.

FIG. 2 shows a first variant of the rotary tool assembly 1. The rotary tool assembly 1 may include, in particular, a hub arrangement 5, a guide arrangement 6, a tool arrangement 7 (or lower tool arrangement), a tool arrangement 8 for upper tool arrangement), a second guide arrangement 9, a drive arrangement 10, a CPU arrangement 11, a battery arrangement 12.

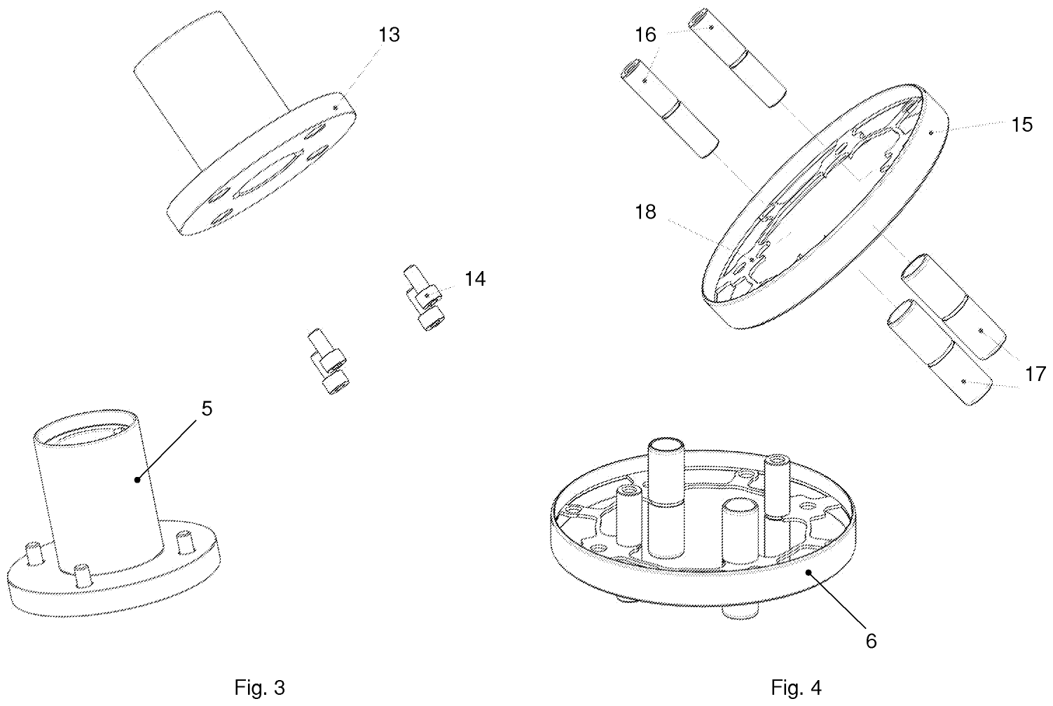

FIG. 3 shows the hub arrangement 5 as a whole, present both in the first Mariam of FIG. 2 and in the second variant of FIG. 16. The hub arrangement 5 may be configured, in particular, to connect the rotary tool assembly 1 to a shaft of the motor 2 of a machining machine.

The hub arrangement 5 may include, in particular, a hub portion 13 (for in example in the form of a hollow cylindrical body), a flange portion arranged at one end of the hub portion 13, and fixing members 14, for example of the screw type (in the specific example with four screws) configured for mutual fastening between the various component arrangements of the entire rotary tool assembly 1.

The rotary tool assembly 1 may be fixed to the motor 2, for example by means of screw fastening or other fastening members provided by the manufacturer of the machining machine.

It is noted that the rotary tool assembly consists of an independent unit whose various components are connected to each other in such a way as to form a separate assembly, so there is the possibility of using different hubs. The diameter and length of the part (cylindrical hub) that is inserted inside the assembly may be considered binding.

FIG. 4 shows the guide arrangement 6, present both in the first variant of FIG. 2 and in the second variant of FIG. 16. The guide arrangement 6 may be arranged, in particular, in a central area of the rotary tool assembly 1.

The guide arrangement 6 is configured to keep in guide the tool arrangements 7 and 8 and/or to support a protection ring 15. The guide arrangement 6 may include, in particular, the protection ring 15 configured to prevent the entry of foreign bodies into a space between the tool arrangements 7 and 8.

The guide arrangement 6 may include, in particular, a spacer device configured for the spacing between the various aforementioned arrangements and/or to act as guide device for the tool arrangements 7 and 8. The spacer device may include, in particular, one or more neutral spacers 16, for example spacers with (cylindrical) surfaces ground to a in glossy finish to minimize friction. The spacer device may include, in particular, one or more motor spacers 17, for example spacers with (cylindrical) surfaces ground with a glossy finish with functions similar to the neutral spacers. The motor spacers 17 may, in particular, be configured with a hollow execution to contain and protect the motor arrangements with encoders arranged in the drive arrangement 10. The guide arrangement 6 may include, in particular, a support 18 (rigidly connected to the protection ring 15) configured to support and lock the protection ring 15 in the center of the spacer device. Each spacer 16 and 17 may include, as in these examples, a central portion constrained to the support 18.

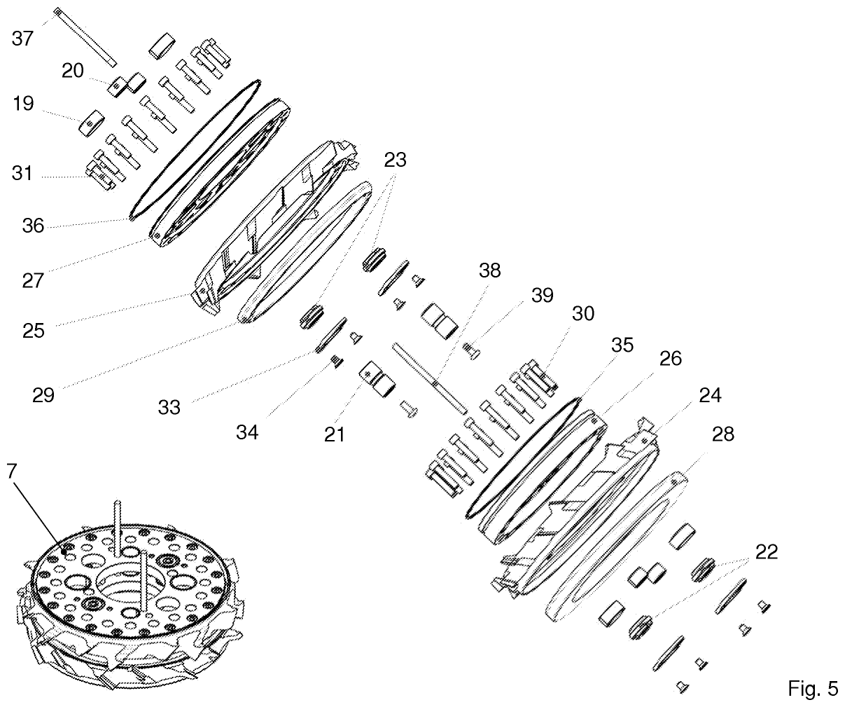

FIG. 5 shows the lower tool arrangement 7 in these examples present only in in the version of FIG. 2) configured to support a pair of tool bodies (for example a pair of milling cutter bodies). The mutual distance of the two tool bodies of a pair of the lower tool arrangement 7 may be adjusted, in the axial direction, symmetrically with respect to a central working reference point.

The lower tool arrangement 7 may include, in particular, a plurality of bushings, for example four bushings 19 and four bushings 20, which define a plurality of guide points (in this example four guide points).

The lower tool arrangement 7 may include, in particular, one or more (in this case two) adjustment screws 21 and one or more (in this case two) right threaded bushings 22 and one or more (in this case two) left threaded bushings 23. The adjustment screws 21, coupled to the relative threaded bushings, right 22 and left 23, allow to obtain opposite directions in the adjustment movement of the tool bodies. The adjusting screws 21 are placed on two opposite axes with respect to a central axis, in order to provide two further guiding members and/or in such a way as to perform the task of distributing the thrust force on two fulcrum areas, obtaining fluidity and greater precision in positioning.

As mentioned, the lower tool arrangement 7 includes a pair of tool bodies (for example a pair of milling cutter bodies, both right), in particular a smaller tool body 24 and a larger tool body 25, which are the working part of the assembly and therefore are subject to wear as a result of sharpening.

The tool bodies 24 and 25 are fixed to respective tool holders 26 and 27 through respective tool locking rings 28 and 29 and through respective sets of screws 30 and 31. The tool holders 26 and 27 are, joined together by an adjustment system including the adjustment screws 21 coupled to the threaded bushings 22 and 23.

The threaded bushings are fixed to the tool holders 26 and 27 by means of bush locks 33 with relative fixing screws 34. This locking system allows the threaded bushings 22 and 23 to be phased with the adjustment screws 21, so as to obtain precise centering and in order to make the threaded bushings with a material suitable for reducing friction with the adjustment screws.

There may be arranged on the tool holders 26 and 27, in particular, a first O-ring 35 (for example 140 mm) for sealing between the two tool bodies 24 and 25, and a second O-ring 36 (for example 160 mm) for sealing in the central area on the protection ring 15. There may be arranged on the tool holders 26 and 27, in particular, two rods 37 and 38 configured to signal (by means of a contact action) to the electronic control device (CPU arrangement 11) the maximum safe opening and closing and to phase the encoder of the motor arrangements of the drive arrangement 10, when necessary. The various positions, in particular the opening and closing points of operation, may be managed by the electronic control device. In particular, a respective fixing screw 39 may be coupled to each adjustment screw 21.

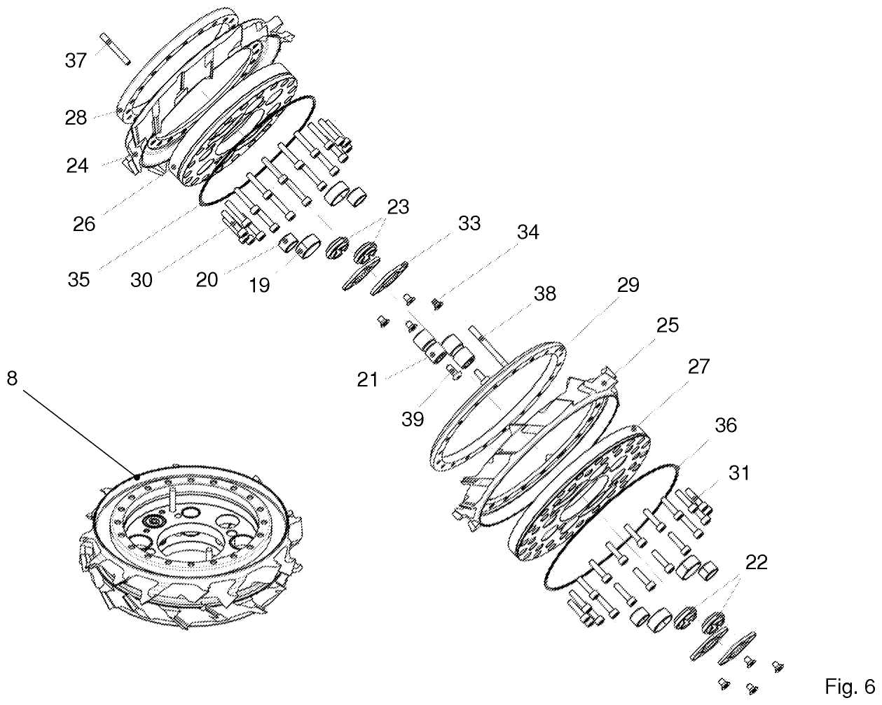

FIG. 6 shows the upper tool arrangement 8, present in both versions of FIGS. 2 and 16. The upper tool arrangement 8 may have, in particular, characteristics substantially similar to the lower tool arrangement 7.

The upper tool arrangement 8 may include, in particular, tool bodies 24 and 25, winch are the working pan subject to wear as a result of sharpening. The tool bodies are fixed to tool holders 26 and 27 by means of tool locking rings 28 and 29 and screws 30 and 31. The two tool holders are joined together by an adjustment system with two adjustment screws 21 screwed to threaded bushings 22 and 23 right and left. The threaded bushings are fixed to the tool holders by means of bush locks 33 and fixing screws 34. This locking system allows the threaded bushings to be phased with the adjusting screws, positioning them in a centered way with precision and/or allows to realize the threaded bushings made of material suitable for reducing friction with the adjustment screws.

A first O-ring 35 (for example 140 mm) for sealing between the two tool bodies, and a second O-ring 36 (for example 160 mm) for the central seal on the protection ring 15 are positioned on the tool holders. On the tool holders there are two rods 37 and 38 which signal the maximum safety opening and closing to the electronic control device and in phase the encoder of the motor arrangements when necessary. The positioning, in particular the opening and closing points of operation, may be managed by the control device.

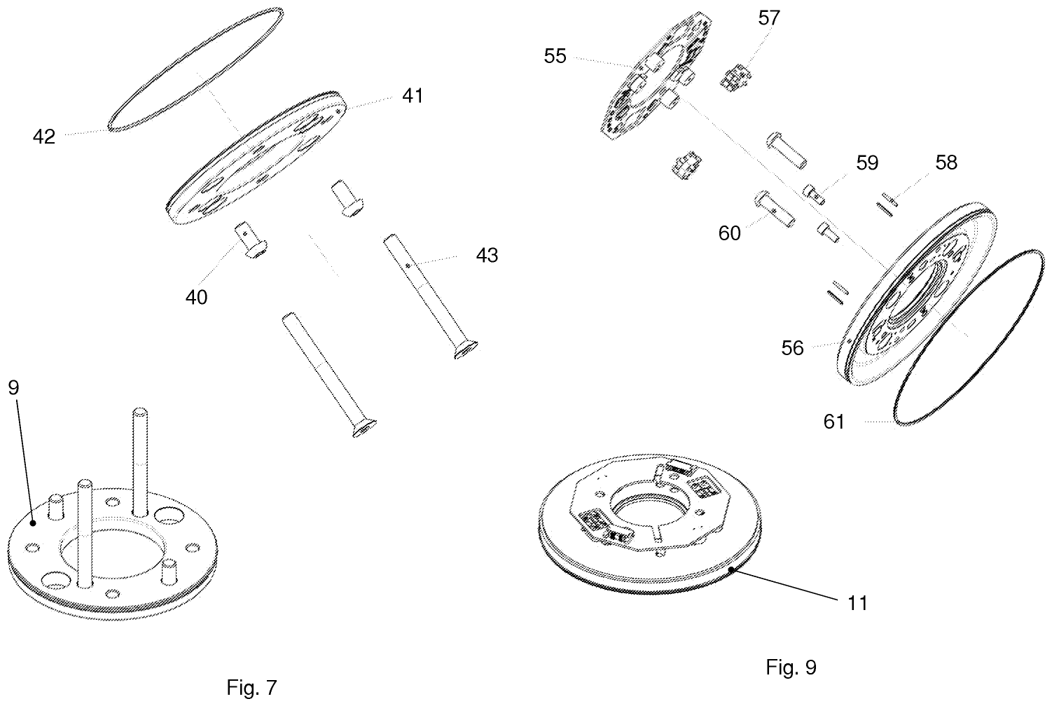

FIG. 7 shows the second guide arrangement 9 (in these examples present only in the version of FIG. 2) configured to fix the set of arrangements formed by the guide arrangement 6, the lower tool arrangement 7 and the upper tool arrangement 8, by means of fastening members, for example including two screws 40, and to fasten the drive arrangement 10 to this set of arrangements as well. The second guide arrangement 9 may be configured, in particular, to join the assembly 1 to the hub by means of a plurality of threaded holes (in this example tour in number).

The second guide arrangement 9 may include, in particular, a guide flange 41 for fixing the hub and the various arrangements, and for housing a sealing O-ring 42 with the lower tool arrangement 7. The second guide arrangement 9 may include, in particular, the two screws 40 for fastening to the guide arrangement 6 by screwing them to the neutral spacers 16. The second guide arrangement 9 may include, in particular, two screws 43 for fastening to the drive arrangement 10.

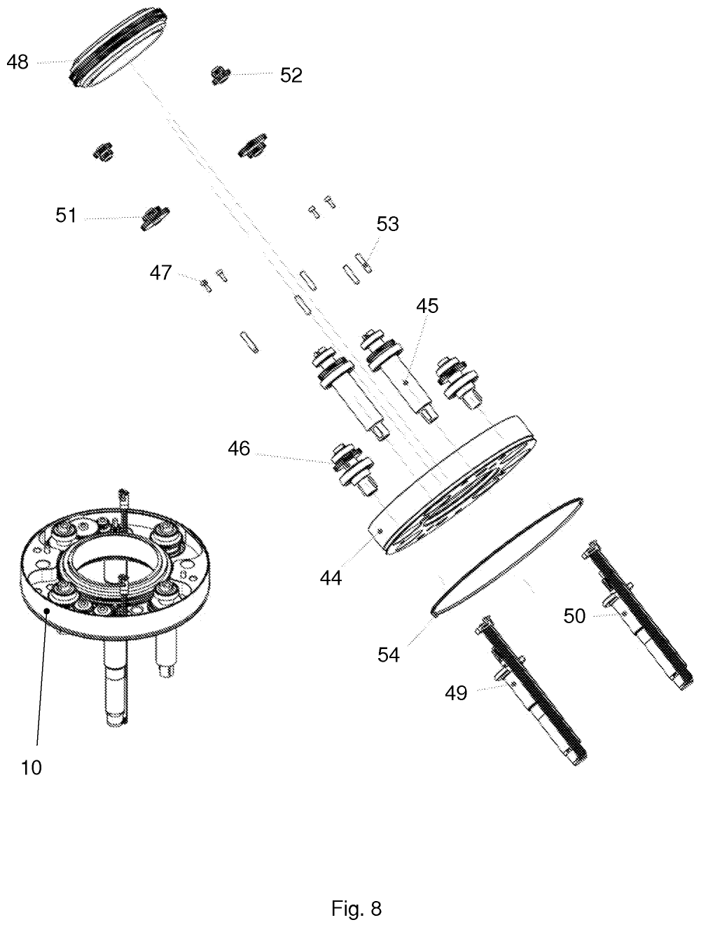

FIG. 8 shows the drive arrangement 10 (hi these examples present only hi the version of FIG. 2) configured, in particular, to bring the movement from the motor arrangements to the adjustment screws 21 of the tool arrangements 7 and 8. The drive arrangement 10 allows to apply a torsional force to each motor group such as to avoid overloads to the motor arrangement itself, avoiding overheating of the motor arrangement and/or damage to the reducer of the motor arrangement and reducing energy consumption. The drive arrangement 10 includes a gear device shaped and arranged with reduced overall dimensions and minimum friction.

The drive arrangement 10 may include, in particular, a container 44 for housing mechanical pans and for positioning them for protection from foreign bodies. The drive arrangement 10 may include, in particular, one or more (in this case two) transmission shafts 45 (lower) and one or more (in this case two) transmission shafts 46 (upper), configured to transmit the movement to the adjusting screws 21 of the tool arrangements 7 and 8. The drive arrangement 10 may include, in particular, screws 47 for fixing these transmission shafts.

It should be observed that the adjustment screws 21 are separated from the transmission shafts 45 and 46 in such a way as to facilitate the separation of the two groups of elements, in the phase of replacement of the tool bodies, without losing the coupling phase.

The drive arrangement 10 may include, in particular, a crown arrangement 48 configured to transmit movement to the drive shafts 45 and 46.

The drive arrangement 10 may include, in particular, two motor arrangements 49 and 50. The drive arrangement 10 may include, in particular, a plurality of pinions 51 and 52. The drive arrangement 10 may include, in particular, a plurality of pins 53 configured to act as shafts for the pinions 51 and 52 and/or to act as phase positioning device for the CPU arrangement 11. The drive arrangement 10 may include, in particular, a plurality of screws 47 for fixing the motor arrangements 49 and 50. The drive arrangement 10 may include, in particular, at least one O-ring 54 for sealing the tool arrangement.

FIG. 9 shows the CPU arrangement 11 (present in both versions of FIGS. 2 and 16) which includes the electronic and programmable control device for managing the operation of the assembly 1. The CPU arrangement 11 may include, in particular, at least one CPU card 55 with electronic control modules and at least one program with computer instructions for operation. The CPU card 55 may include, in particular, an antenna configured, in particular, for receiving the commands to be executed. The commands may be supplied, for example, by means of a remote control for use by an operator, who can select, when desired, the type of executable program to be transmitted to the CPU arrangement 11. The commands may be supplied, for example, by means of a CNC of the machine that uses the assembly. It is therefore possible to provide (with an external command, for example via remote control, PLC, CNC, etc.), the commands suitable to perform a desired movement, such as a partial or alternating movement (closing and opening continuously), or other programmable sequence.

The commands may be provided, for example, by means of the optical sensor S (see FIG. 1) configured to detect the machining (for example the type of finish) that the assembly tools are performing. In this case the operator may choose, for example, a minimum acceptable degree of finish and then set one or more processing parameters (in particular of movements), so when the optical sensor S detects a value different from a set value, the CNC will be able to provide a signal to the CPU arrangement 11 of the assembly in order to perform a correction action (for example a calculated movement, so as to position the cutting edge on a new machining point), restoring a desired machining finish.

The CPU arrangement 11 may include, in particular, a support flange 56 configured to support the CPU board 55. The support flange 56 may also be configured to act as a cover for the drive arrangement 10. The CPU arrangement 11 may include, in particular, one or more (for example two) micro limit switch arrangements 57, in particular arranged on the support flange 56. In this case a micro limit switch arrangement 57 is arranged for the safety limit of maximum mutual distance between the took (fully open), and a micro limit switch arrangement 57 for the safety limit of minimum mutual distance between the tools (fully closed).

The CPU arrangement 11 may include, in particular, one or more pins SK for in positioning the micro-limit switch arrangements. The CPU arrangement 11 may include, in particular, fixing members 59 (for example of the screw type) for fixing the CPU arrangement 11 to the drive arrangement 10. The CPU arrangement 11 may include, in particular, fixing members 60 (for example of the screw type) for fixing the CPU arrangement 11 and the drive arrangement 10 to the guide arrangement 6, in particular by means of screw couplings with the neutral spacers 16. The CPU arrangement assembly II may include, in particular, at least one O-ring 61 configured to seal with the upper tool arrangement 8.

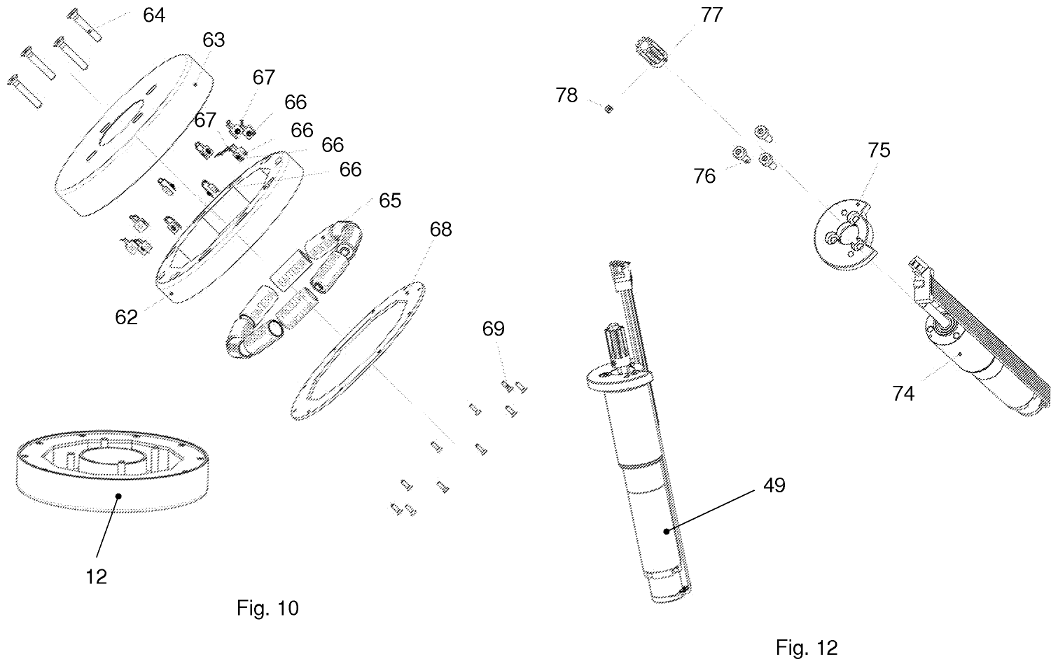

FIG. 10 shows the battery arrangement 12 (present in both versions of FIGS. 2 and 16) configured to supply energy autonomously to the assembly 1. The battery arrangement 12 may be configured, in particular, to contain a plurality of batteries. The battery arrangement 12 may be configured, in particular, to act as a cover for the CPU arrangement 11, in order to provide protection against the very dusty environment in which the assembly 1 must operate. This functionality is allowed, in particular, thanks to the reduced energy consumption of assembly 1.

The battery arrangement 12 may include, in particular, a case 62 for containing the batteries, in particular a case of toroidal shape, to allow a relatively large space to be left for the CPU arrangement 11 and/or to be relatively light. The battery arrangement 12 may include, in particular, a cover 63, in particular to protect the CPU board, and fixing screws 64 of the cover 63. The battery arrangement 12 may include, in particular, a plurality of batteries 65, various elements of electrical contact 66 of the batteries and various electrical connection cables 67. The battery arrangement 12 may include, in particular, a battery cover 68 for protecting the batteries and fastening screws 69 of the battery cover.

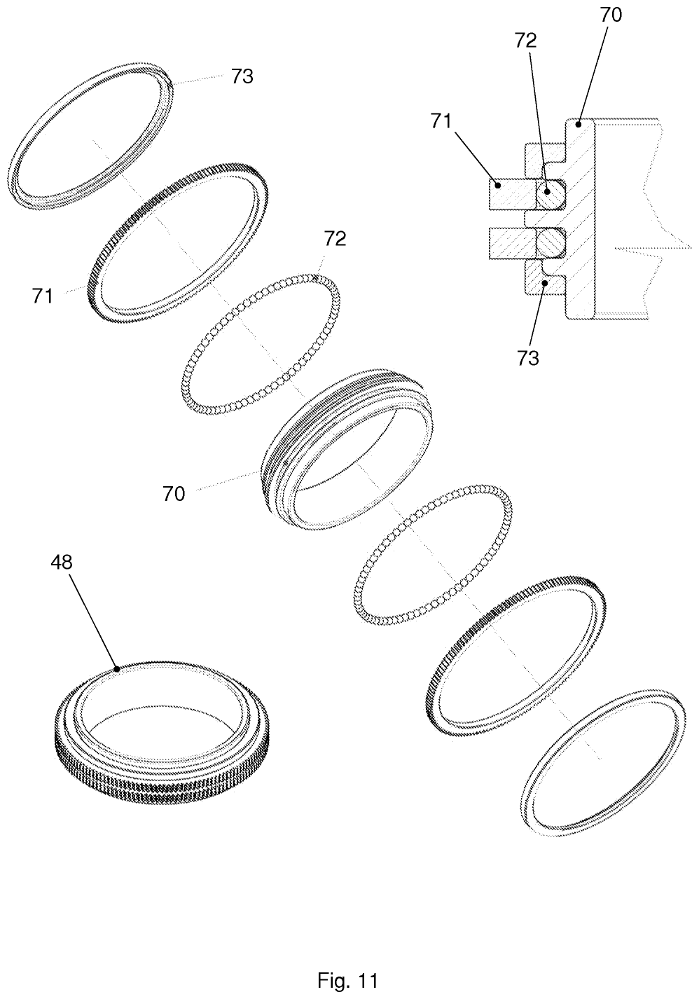

FIG. 11 shows in greater detail the crown arrangement 48 (in these examples present only in the version of FIG. 2) configured to transmit the movement from the motor arrangement to the two opposing shafts. The crown arrangement 48 allows, in particular, to facilitate the assembly of the spheres and to avoid the risk of the spheres coming out.

The crown arrangement 48 may include, in particular, a ring 70 for containing the spheres and supporting the crowns. The crown arrangement 48 may include, in particular, one or more crowns 71 (in this case two crowns) made of a material, for in example brave, suitable for reducing friction and at the same time sufficiently soft to run in and adapt to the spheres. The crown arrangement 48 may include, in particular, a plurality of spheres 72 (for example with a diameter of 2.5 mm). The crown arrangement 48 may include, in particular, one or more ring nuts 73 (in this case two ring nuts) each configured to stop a respective crown in position.

FIG. 12 shows, in greater detail, the motor arrangement 49 (present in both versions of FIGS. 2 and 16) which may include, in particular, a gearmotor 74 (in particular with encoder). The motor arrangement 49 may include, in particular, a motor support ring nut 75, which may be provided, in particular, with a slot for passage for cables. The motor arrangement 49 may include, in particular, fixing members 76 (for example of the screw type) for fixing the gearmotor 74 to the ring nut. The motor arrangement 49 may include, in particular, a pinion 77 which may be provided, in particular, with a fixing dowel 78.

The assembly version of FIG. 2 may include, in particular, also the motor arrangement 50, which may have, in particular, the same characteristics and the same components as the motor arrangement 49, possibly with a different position of the pinion.

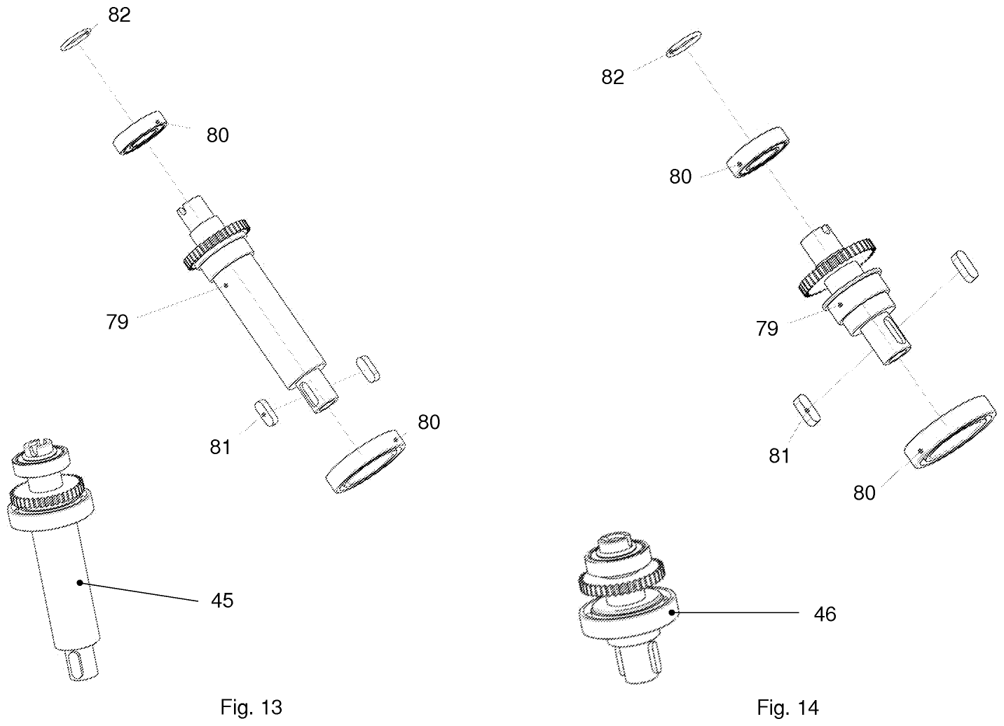

FIG. 13 shows, in greater detail, a transmission shaft 45 (lower, in these examples present only in the version of FIG. 2). The transmission shaft 45 allows to facilitate the mutual separation between the contiguous arrangements. In particular, the presence of keys makes it possible not to lose the phase with the adjustment screws. The keys are configured to leave a space that will be useful for the threaded hole for fixing the adjustment screws. It is possible, as in this example, to apply a cut in a portion of the upper end for a possible version of the assembly with manual control, alternatively or in combination with the motorized control.

The transmission shaft 45 may include, in particular, a tool shaft 79 and one or more (in the specific example two) radial bearings 80. The transmission shaft 45 may include, in particular, one or more (in the specific example two) keys 81 inserted in slots on the tool shaft 79. The transmission shaft 45 may include, in particular, at least one sealing O-ring 82 to protect the CPU board 55 against the leakage of oil or grease.

FIG. 14 shows, in greater detail, a transmission shaft 46 (upper, present in both versions of FIGS. 2 and 16). The transmission shaft 46 may have, in particular, the same characteristics as the transmission shaft 45 (lower). The transmission shaft 46 may include, in particular, a tool shaft 79, one or more radial bearings 80, one or more keys 81, at least one sealing O-ring 82 to protect the CPU board against the leakage of oil or grease.

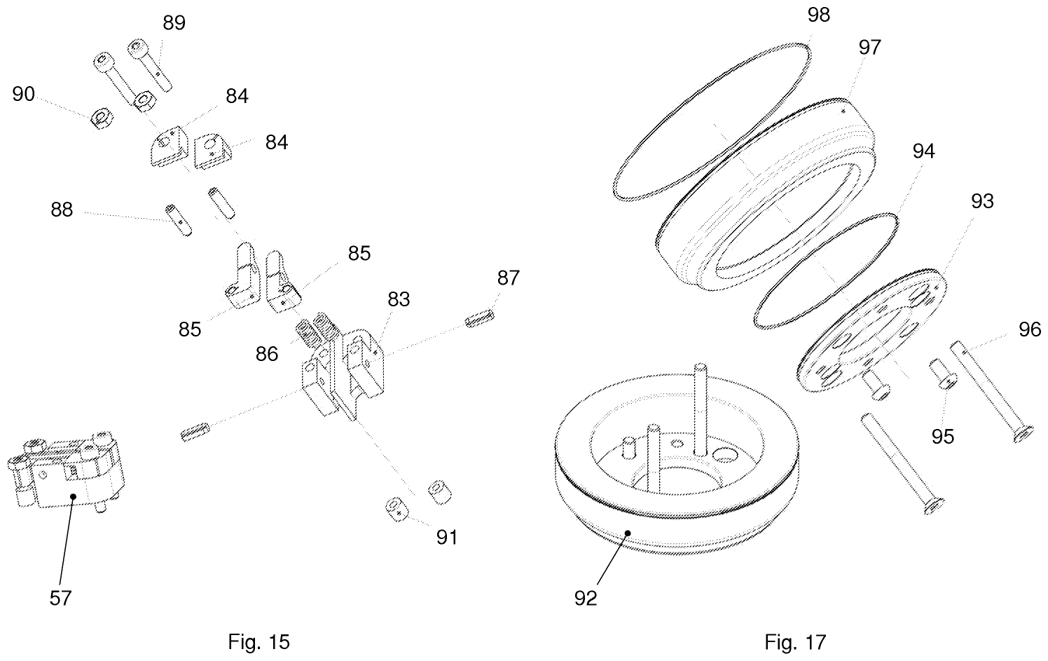

FIG. 15 shows, in greater detail, a micro-limit switch arrangement 57 (present in both versions of FIGS. 2 and 16) which makes it possible to ensure protection of the motor arrangements. The micro limit switch arrangement 57 may be, in particular, configured to interrupt the power supply in case of intervention, so that the motor arrangements are automatically excluded and protected in the event of their failure.

Each limit switch micro arrangement 57 may be arranged, as in this case, in the assembly portion (CPU arrangement 11) which contains the CPU board 55. Each limit switch micro arrangement 57 may be connected in contact, as in this case, to the rods 37 and 38 configured to operate the respective micro switches. This allows an adequate positioning of the micro switches and the possibility of an appropriate passage of the cables. The special configuration of the rods and of the micro-limit switch arrangements allows to maintain a desired balance in weight balancing.

The micro limit switch arrangement 57 may include, in particular, a micro body 83, for example made of insulating plastics. The micro limit switch arrangement 57 may include, in particular, one or more (in this case two) contact elements 84. The micro limit switch arrangement 57 may include, in particular, one or more rocker levers 85, in particular a right liking lever and a left tilting lever. The micro limit switch arrangement 57 may include, in particular, an elastic member 86 (for example one or more torsion springs) arranged to keep the levers in the closed circuit position.

The micro-limit switch arrangement may include, in particular, a lever fixing in member 87, for example with one or more fixing pins. The micro limit switch arrangement may include, in particular, one or more adjustment dowels 88 for adjusting the contact of the levers. The micro limit switch arrangement may include, in particular, a fixing member 89 (for example of the screw type) for fixing the micro switch. The micro-kart switch arrangement may include, in particular, a fixing member 90 for fixing the cables and locking the adjustment screws. The micro-limit switch arrangement may include, in particular, an insulating member 91 (for example of tubular shape) arranged to electrically isolate the mutual contact between the levers 85 and the respective rods 37 and 38.

FIG. 16, as said, shows the assembly version with a single pair of tool bodies.

FIG. 17 shows a second guide arrangement 92 (present only in the version of in FIG. 16) with some characteristics similar to those of the second guide arrangement 9 of the version of FIG. 2.

The second guide arrangement 92 may include, in particular, at least one guide flange 93 for fixing the hub and the various arrangements of the assembly 1. The guide flange may be configured to house at least one O-ring 94 arranged for the sealing the lower tool arrangement 7. The second guide arrangement 92 may include, in particular, a fixing member 95 (for example one or more screws) for fixing to the neutral spacers 16. The second guide arrangement 92 may include, in particular, an additional fastening member 96 (for example one or more screws) for fastening to the drive arrangement (in this case with a single motor arrangement). The second guide arrangement 92 may include, in particular, a lower cover 97 arranged to protect and cover the lower part and/or to house an O-ring 99 arranged to seal the ring of the guide arrangement 6.

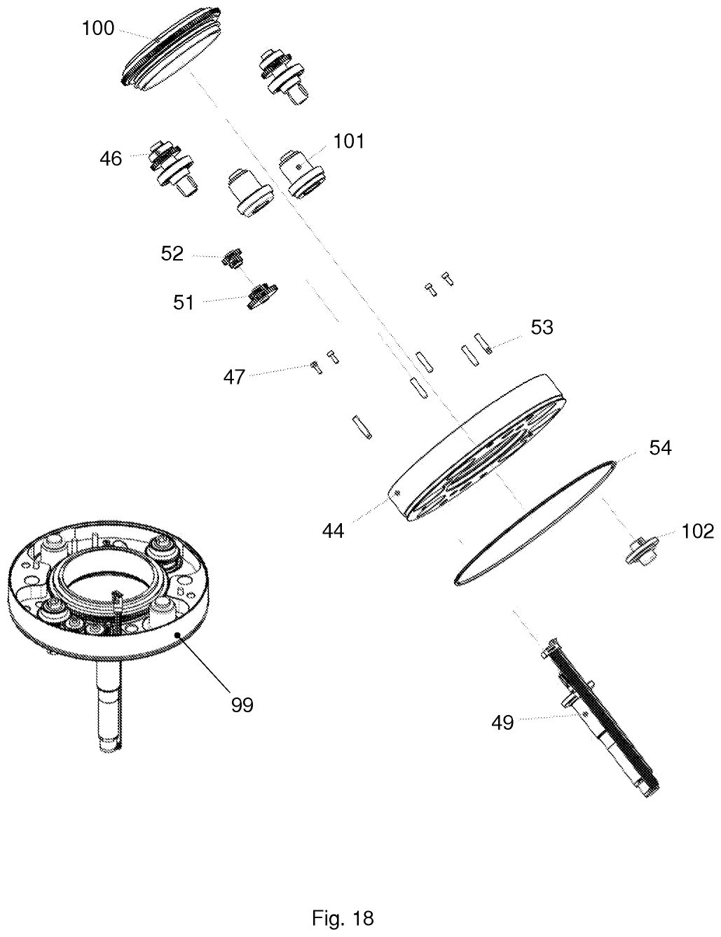

FIG. 18 shows a drive arrangement 99 (present only in the version of FIG. 16) configured to perform functions similar to those of the drive arrangement 10 of the version of FIG. 2. In this case, the drive arrangement 99) will control only one tool arrangement 7. The drive arrangement 99 may include, in particular, a container 44 configured for containing the mechanical parts, for their positioning and for protection from foreign bodies.

The drive arrangement 99 may include, in particular, one or more transmission shafts 46, each configured to transmit motion to the adjusting screws of the tool arrangement and, by means of the screws, to lix the tool arrangement. The adjustment screws are separated from the transmission shafts in order to facilitate the separation of the in two arrangements during the tool replacement phase, without losing the coupling phase.

The drive arrangement 99 may include, in particular, a crown arrangement 100 configured to transmit movement to the drive shafts 46. The drive arrangement 99 may include, in particular, a motor arrangement 50 and one or more pinions 52 and 53. The drive arrangement 99 may include, in particular, one err more pins 53 configured to act as shafts for the pinions and for the phasing of the CPU arrangement. The drive arrangement 99 may include, in particular, fixing members (for example a plurality of screws 47) for fixing the motor arrangement. The drive arrangement 99 may include, in particular, at least one O-ring 54 for sealing with the tool arrangement. The drive arrangement 99) may include, in particular, one or more bearing housing caps 101 to cover the empty seats of the lower shafts (not present). The drive arrangement 99 may include, in particular, a motor cap 102 to cover the empty seat of the second motor (not present) and with the counterweight function (to balance the missing parts with respect to the assembly of FIG. 2).

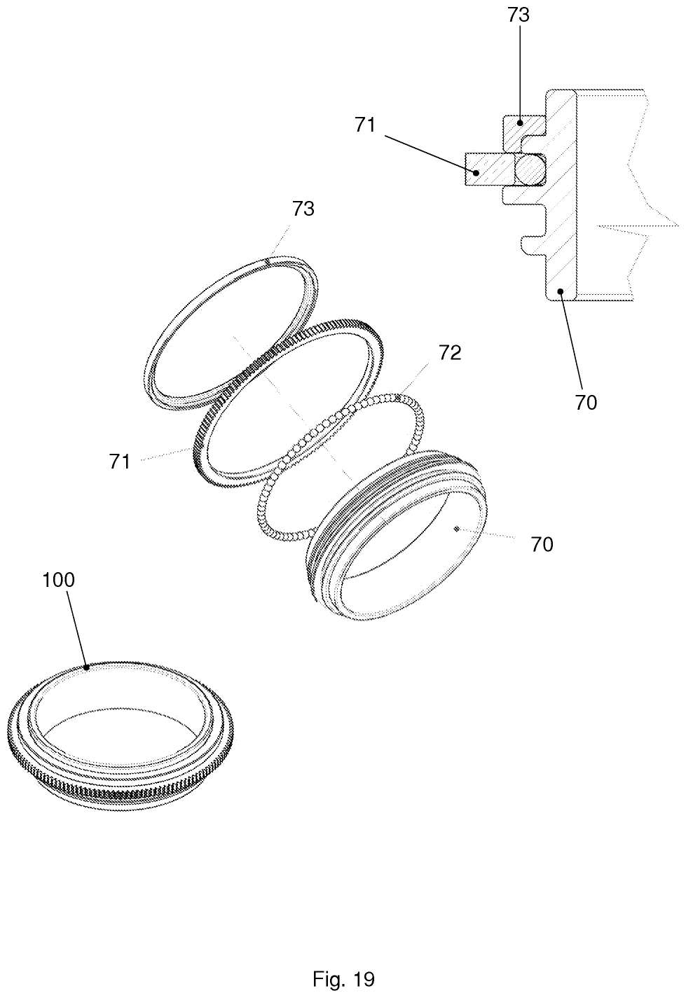

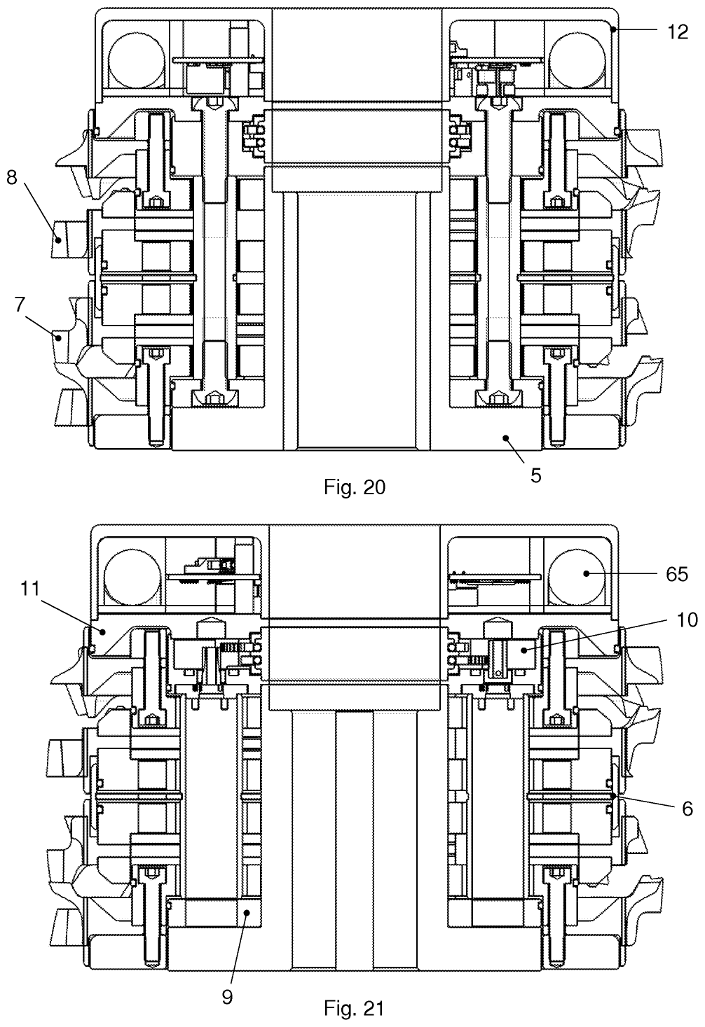

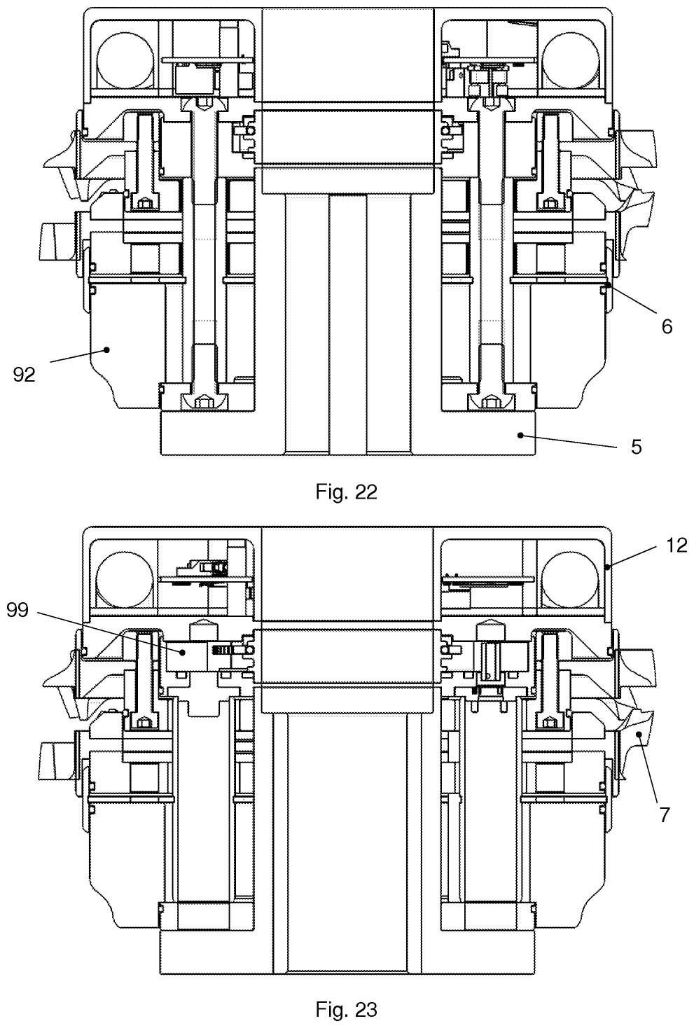

FIG. 19 shows a crown arrangement 100 (present only in the version of FIG. 16) arranged to perform a function similar to the crown arrangement 48 of the version of FIG. 2, but configured for mounting a single crown. The elements similar to the crown arrangement 48 have been indicated with the same numbering.

The rotary tool assembly 1 may include, in particular as in the illustrated examples, a hub arrangement 5 with a hub portion 13 and with a flange portion disposed at a first end of the hub portion 13. The hub arrangement 5 may include, in particular, a tubular (cylindrical) body with an internal through cavity (cylindrical). The assembly 1 may include, in particular, a battery arrangement 12 with a cover 63 arranged at a second end of the hub portion 13 opposite the aforementioned first end. The battery arrangement 12 may include, in particular, a ring arrangement of one or more batteries 65 arranged around an axis of the hub portion 13. The battery arrangement 12 may include, in particular, an annular (toroidal) shaped case 62 containing the aforementioned ring arrangement of one or more batteries 65.

The assembly 1 may include, in particular, a guide arrangement 6 with a protection ring 15 arranged around the axis of the hub portion 13. The protection ring 15 may be arranged, in particular, between the flange portion and cover 63. The guide arrangement 6 may include, in particular, a support 18 arranged inside the protection ring 15. The guide arrangement 6 may include, in particular, two or more spacers 16 and 17, for example two pairs of spacers 16 and 17. Each spacer 16 and 17 may be extended, in particular, in the direction of the axis of the hub portion 13. Each spacer 16 and 17 may include, in particular, a fixed central portion (for example with interlocking coupling) on the support 18 and two end portions (for example cylindrical in shape) arranged on two opposite sides with respect to the support 18.

The assembly 1 may include, in particular, a second guide arrangement 9 with an annular guide flange 41 attached to the flange portion. The guide flange 41 may be, in particular, arranged around the axis of the hub portion 13 between the flange portion and the cover 63. The second guide arrangement 9 may include, in particular, fastening members 40 coupled to at least one of the aforementioned spacers so as to fix the guide flange 41 to the guide arrangement 6. The second guide arrangement 9 may include, in particular, fixing members 43 arranged to fix the guide flange 41 to the drive arrangements 10 or 99. The second guide arrangement 9 may include in particular, a sealing member 42 for sealing between the flange portion and the tool arrangement 7.

The assembly 1 may include, in particular, at least one tool arrangement 7 with two tool holders 26 and 27 each of annular shape arranged around the axis of the hub portion 13. Each tool holder 26 and 27 may be arranged, in particular, between the flange portion and the cover 63. The tool arrangement 7 may include, in particular, two tool bodies 24 and 25 coaxial to each other and each fixed to a respective tool holder 26 and 27. The tool arrangement 7 may include, in particular, two rods 37 and 38 extending in length in the axial direction. Each rod 37 and 38 may be, in particular, fixed to a respective tool holder 26 or 27. The tool arrangement 7 may include, in particular, an adjustment system for adjusting the mutual axial distance between the two tool bodies 24 and 25. The adjustment system may include, in particular, two adjustment screws 21 each with two threaded bushings 22 and 23 with opposite threading directions (one right and one left) and each fixed to a respective tool holder 26 or 27.

The assembly 1 may include, in particular, a drive arrangement 10 or 99 with an annular-shaped container 44 arranged around the axis of the hub portion 13 between the flange portion and the cover 63. The drive arrangement 10 or 99 may include, in particular, a motor arrangement 49 mounted on the container 44. The motor arrangement 49 may include, in particular, a gear motor 74 inserted at least partially in an internal cavity present in a tubular-shaped spacer 16.

The drive arrangement 10 or 99 may include, in particular, two transmission shafts 46 mounted on the container 44 and each configured to actuate rotations of a respective adjustment screw 21. The drive arrangement 10 may include, in particular, a crown arrangement 48 configured to transmit movement from the motor arrangement 49 to the drive shafts 46.

The crown arrangement 48 may include, in particular, a ring 70 and a toothed crown 71 rotatably coupled (by means of spheres 72) to the ring 70. The toothed crown 71 may be arranged, in particular, to transmit motion simultaneously to both drive shafts 46.

The assembly 1 may include, in particular, a CPU arrangement 11 with a support flange 56 arranged between the drive arrangement 10 or 99 and the cover 63. The CPU arrangement 11 may include, in particular, two micro limit switch arrangements 57 each configured to interact in contact with a respective rod 37 or 38 to signal the achievement of two safety limit configurations. The CPU arrangement 11 may include, in particular, a CPU 55 board which in turn may include, in particular, a receiving antenna.

The assembly 1 may include, in particular, a further tool arrangement 8 (see version of FIG. 2) with two further tool holders 26 and 27, two further tool bodies 24 and 25, two further rods 37 and 38, and a further system for adjusting the reciprocal axial distance of the further tool bodies 24 and 25. The drive arrangement 10 (see version of FIG. 2) may include, in particular, a further motor arrangement 50 mounted on the container 44. The further motor arrangement 50 may include, in particular, two further transmission shafts 45 mounted on the container 44 and each configured to actuate a respective further adjustment screw 21.

The crown arrangement 48 (see version of FIG. 21 may include, in particular, a further toothed crown 71 rotatably coupled to the ring 70 and arranged to receive motion from the further motor arrangement 50 and to yield motion to both of the aforementioned additional drive shafts 45.

The assembly 1 may include, in particular, a protection ring 15 arranged at a circular interface line that separates the tool arrangement 7 (or lower tool arrangement) from the further tool arrangement 8 (or upper tool arrangement).

The tool arrangement 7 (as well as, similarly, the further tool arrangement 8) may include in particular, a first sealing ring 35 for sealing between the two tool bodies 24 and 25, and a second sealing ring 36 for the internal seal between the tool arrangement 7 and the protection ring 15.

Each transmission shaft 45 or 46 may be, in particular, connected to a respective adjustment screw 21 by means of a mechanical connection of the shaft-hub type comprising, in particular, at least two opposite keys 81.

The drive arrangement 10 or 99 may include, in particular, two or more pins 53 each configured to act as a shaft for a respective pinion 51 or 52 connected to the ring gear 71, and/or to act as a positioning device for the CPU arrangement 11.

The assembly 1 may include, in particular (see example of FIG. 16), a motor plug 102 arranged to cover an empty seat suitable for housing a further motor arrangement and configured in such a way as to act as a counterweight to balance the absence of the further motor arrangement.

The assembly 1 has reduced friction and play between the various parts that compose it, making the movements in the adjustment phases fluid and precise, despite the almost total absence of play. The assembly 1 has a structure with high resistance to wear and self-cleaning configuration in the event of infiltration of dust, ensuring the protection of the system and avoiding blocking or misalignment of the tools during movements, and maintaining the desired conditions of use over time.

The assembly 1 allows to control the movement (opening and closing) of two or more tool bodies (in particular milling cutter bodies) by applying three on two opposing and symmetrical axes, favoring stability and balancing.

The assembly 1 allows a certain versatility, thanks to its modularity, so that it can accommodate different cutter bodies and/or combinations of cutter bodies, it can replace them when exhausted, without changing the pan that controls the adjustment, as the part of adjustment is not subject to consumption.

The assembly 1 is in practice independent of the system for locking the assembly itself to the machine hawing the motor that controls the rotation, since the part of the tool set up for adjustment is separate and distinct tom the part that receives the rotation to perform the machining, making any type of attachment between tool and machine usable (expandable HYDRO bushings, simple hubs with or without keys, HSK, attachments, etc.), also making it possible to make adjustments even during machining, without necessarily stopping production.

1. Rotary tool assembly, including:
a hub arrangement with a hub portion and with a flange portion arranged at a first end of said hub portion;
a battery arrangement with a cover arranged at a second end opposite said first end of said hub portion, and with an annular arrangement of one or more batteries around an axis of the said hub portion;
at least one tool arrangement with two tool holders each of which is annular in shape around said axis of said hub portion between said flange portion and said cover, with two tool bodies coaxial with each other and fixed, each, to a respective tool holder, with two rods extending axially in length and arranged, each, on a respective tool holder, and with a mutual axial distance adjustment system which joins together said two tool holders and which includes two adjustment screws each of which is coupled to two threaded bushings with opposite thread directions and fixed, each, to a respective tool holder;
a drive arrangement with an annular-shaped container arranged around said axis of said hub portion between said flange portion and said cover, with at least one motor arrangement mounted on said container, and with at least two transmission shafts mounted on said container and configured, each, to activate a rotation of a respective adjusting screw;
a CPU arrangement with a support flange arranged between said drive arrangement and said cover, with a CPU board mounted on said support flange, and with two micro limit switch arrangements arranged on said support flange and configured, each, to interact in contact with a respective rod to signal the occurring of two safety limit configurations of said at least one tool arrangement.

2. Assembly according to claim 1, including a guide arrangement with a protection ring arranged around said axis of said hub portion between said flange portion and said cover, with a support arranged inside said protection ring, and with two or more spacers each of which is extended in direction of said axis of said hub portion and includes a central portion fixed on said support and two end portions arranged on two opposite sides with respect to said support.

3. Assembly according to claim 2, including a second guide arrangement with an annular-shaped guide flange attached to said flange portion and arranged around said axis of said hub portion between said flange portion and said cover, with fastening members coupled to at least one of said two or more spacers so as to fasten said guide flange to said guide arrangement, with fastening members arranged to fasten said guide flange to said drive arrangement, and with a sealing member arranged on said guide flange for sealing between said flange portion and said tool arrangement.

4. Assembly according to claim 2, wherein at least one of said two or more spacers is tubular in shape with an internal cavity, and wherein said at least one motor arrangement includes a gear motor inserted at least in part into said internal cavity in said tubular spacer.

5. Assembly according to claim 2, wherein said tool arrangement includes a first sealing ring for sealing between said two tool bodies, and a second sealing ring for the internal seal between said tool arrangement and said protection ring.

6. Assembly according to claim 2, including a further tool arrangement with two further tool holders each of which is annular in shape around said axis of said hub portion between said flange portion and said cover, with two further tool bodies coaxial with each other and fired, each, to a respective further tool holder, with two further rods extended in length in the axial direction and arranged, each, on a respective further tool holder, and with a mutual axial distance adjustment system which joins together said two further tool holders and which includes two further adjustment screws each of which is coupled to two further threaded bushings of opposite thread directions and each fixed to a respective further tool holder.

7. Assembly according to claim 6, wherein said protection ring is arranged at a circular interface line which separates said tool arrangement from said further tool arrangement.

8. Assembly according to claim 6, wherein said drive arrangement a further motor arrangement mounted on said container, with two further transmission shafts mounted on said container and configured, each, to operate a rotation of a respective further adjustment screw.

9. Assembly according to claim 1, wherein said drive arrangement includes a crown arrangement configured to transmit motion from said at least one motor arrangement to said at least two transmission shafts, said crown arrangement including a ring mounted on said container and at least one crown gear rotatably coupled to said ring and arranged to receive motion from said at least one motor arrangement and to transfer motion to both of said at least two transmission shafts.

10. Assembly according to claim 9, wherein said drive arrangement includes a further motor arrangement mounted on said container, with two further transmission shafts mounted on said container and configured, each, to operate a rotation of a respective further adjustment screw, said crown arrangement including a further crown gear rotatably coupled to said ring and arranged to receive motion from said further motor arrangement and to transfer motion to both said two further transmission shafts.

11. Assembly according to claim 9, wherein said drive arrangement includes two or more pins each of which is configured to operate as a shaft for a respective pinion connected to said at least one crown gear, and in such a way as to operate as a positioning device for said CPU arrangement.

12. Assembly according to claim 1, wherein each of said at least two transmission shafts is connected to the respective adjustment screw by means of a mechanical connection of the shaft-hub type including at least two opposite keys.

13. Assembly according to claim 1, including a motor cap arranged to cover an empty seat suitable for housing a further motor arrangement and configured to act as a counterweight to balance the absence of the further motor arrangement.

14. Assembly according to claim 1, wherein said CPU board includes a receiving antenna.

15. Assembly according to claim 1, wherein said battery arrangement includes a case of annular shape containing said annular arrangement.
